(19) United States
(12) Patent Application Publication
(10) Pub. No.: US 2008/0041577 A1
(43) Pub. Date: Feb. 21, 2008

(54) Screen for Controlling Inflow of Solid Particles in a Wellbore

(76) Inventors: Matheus Norbertus Baaijens, Rijswijk (NL); Erik Kerst Cornelissen, Rijswijk (NL)

Correspondence Address: SHELL OIL COMPANY, P O BOX 2463, HOUSTON, TX, 772522463, US

(21) Appl. No.: 11/630,458

(22) PCT Filed: Jun. 23, 2005
(86) PCT No.: PCT/EP05/52948

§ 371 Date: Dec. 21, 2006

(30) Foreign Application Priority Data
Jun. 25, 2004 (EP) 04253820.7

(51) Int. Cl. E21B 43/08; C09K 3/00

(52) U.S. Cl. 166/74; 166/227; 507/203

(57) ABSTRACT

A wellbore screen is provided for controlling inflow of solid particles into a wellbore. The wellbore screen comprises a conduit for transport of fluid, the conduit being provided with a filter for reducing inflow of solid particles into the conduit and swelling means arranged between the filter and the wellbore wall. The swelling means defines a plurality of compartments between the filter and the wellbore wall and is susceptible of swelling against the wellbore wall upon contact with a selected fluid so as to substantially prevent flow of fluid along the outside of the swelling means from one of said compartments into another of said compartments.

### BACKGROUND OF THE INVENTION

The present invention relates to a wellbore screen for controlling inflow of solid particles into a wellbore, the wellbore screen comprising a conduit for transport of the hydrocarbon fluid, the conduit being provided with a filter for reducing inflow of solid particles into the conduit.

Stand-alone sand exclusion systems, such as slotted liners or a wire-wrapped screens, generally are applied in wells for producing a stream of fluid from the earth formation and wells for injecting a stream of fluid into the earth formation. The produced and/or injected stream of fluid can be, for example, oil, gas or water. A frequently occurring problem in using such sand exclusion system relates to axial flow of fluid in the annular space between the wellbore wall and the screen. Solids from the surrounding formation which flow with the stream of fluid into the wellbore are thereby transported along the screen and deposited as a layer of very low permeability on the screen. The problem is particularly pronounced in case clay particles enter the wellbore. As a result of such flow of fluid through the annular space plugging of the screen potentially takes place over the full length thereof, which may lead to reduced production of hydrocarbon fluid or water from the well. Moreover, if flow of fluid into the screen is reduced to a local section of the screen not (yet) plugged, excessive erosion of the screen may result.

It is an object of the invention to provide an improved wellbore screen which overcomes the aforementioned problems.

In accordance with the invention there is provided a wellbore screen for controlling inflow of solid particles into a wellbore, the wellbore screen comprising a conduit for transport of fluid, the conduit being provided with a filter for reducing inflow of solid particles into the conduit and swelling means arranged between the filter and the wellbore wall, the swelling means defining a plurality of compartments between the filter and the wellbore wall and being susceptible of swelling against the wellbore wall upon contact with a selected fluid so as to substantially prevent flow of fluid along the outside of the swelling means from one of said compartments into another of said compartments.

By virtue of swelling of the swelling means against the wellbore wall it is achieved that solid particles which may flow with the stream of fluid into the wellbore, are confined to one or a few compartments formed between the filter and the wellbore wall. Plugging of the entire filter due to depositing of such particles along the entire length of the filter is thereby prevented.

The wellbore can be, for example, a production well for the production of hydrocarbon fluid (oil or gas) or water. Alternatively the wellbore can be an injection well for injecting water, oil, gas, waste fluid or another fluid into the earth formation. In either case the selected fluid which causes swelling of the swelling means can be a produced fluid, such as hydrocarbon fluid or water, or an injected fluid such as hydrocarbon fluid (e.g. crude oil, diesel, gas) or water.

In case of a production well for hydrocarbon fluid, fast activation can be achieved by pumping a hydrocarbon fluid (e.g. diesel) or into the wellbore to induce swelling of the swelling means. Once fast swelling is achieved, continued activation occurs by virtue of contact of the swelling means with produced hydrocarbon fluid.

It will be understood that in case of an injection well, the problem of plugging can occur during time intervals that injection is stopped and fluid is allowed to flow back from the wellbore into the screen. In a preferred embodiment the swelling means includes a plurality of swelleable rings, each ring extending around the filter and being susceptible of swelling against the wellbore wall upon contact with the selected fluid, the rings being mutually spaced along the conduit. Suitably the rings are arranged at regular mutual spacings along the conduit.

Alternatively the swelling means includes a sleeve extending around the conduit, the sleeve being provided with a plurality of through-openings spaced along the sleeve. The through-opening can, for example, have a substantially rectangular or substantially circular shape.

It is preferred that the swelling means includes a material susceptible of swelling upon contact with hydrocarbon fluid or water, for example hydrocarbon fluid or water produced from the earth formation.

Suitable materials susceptible of swelling upon contact with water include rubber selected from Nitrile Butadiene rubber, Hydrogenated Nitrile Butadiene rubber, Carboxylated Nitrile Butadiene rubber, Fluor Polymer, TetraFluorEthylene/PolyPropylene, Ethylene-Propylene-Diene Terpolymer rubber, Chloroprene rubber, ChloroSulfonated Polyethylene, Chlorinated Polyethylene, and PolyUrethane rubber.

Suitable materials susceptible of swelling upon contact with hydrocarbon fluid include rubber selected from Natural rubber, Acrylate Butadiene rubber, Butyl rubber, Brominated Butyl rubber, Chlorinated Butyl rubber, Chlorinated Polyethylene, Chloroprene rubber, Styrene Butadiene rubber, Sulphonated Polyethylene, Ethylene Acrylate rubber, Epichlorohydrin Ethylene Oxide Copolymer, Epichlorohydrin Ethylene Oxide Terpolymer, Ethylene-Propylene-Copolymer (Peroxide crosslinked), Ethylene-Propylene-Diene Terpolymer rubber, and Silicone rubber.

Preferably the oil swelling rubber is selected from Ethylene Propylene Copolymer (Peroxide crosslinked), Ethylene-Propylene-Diene Terpolymer rubber, Butyl rubber, Brominated Butyl rubber, Chlorinated Butyl rubber, and Chlorinated Polyethylene.

The invention will be described hereinafter in more detail by way of example, with reference to the accompanying drawings in which:

FIG. 1 schematically shows a longitudinal view of a first embodiment of a wellbore screen according to the invention;

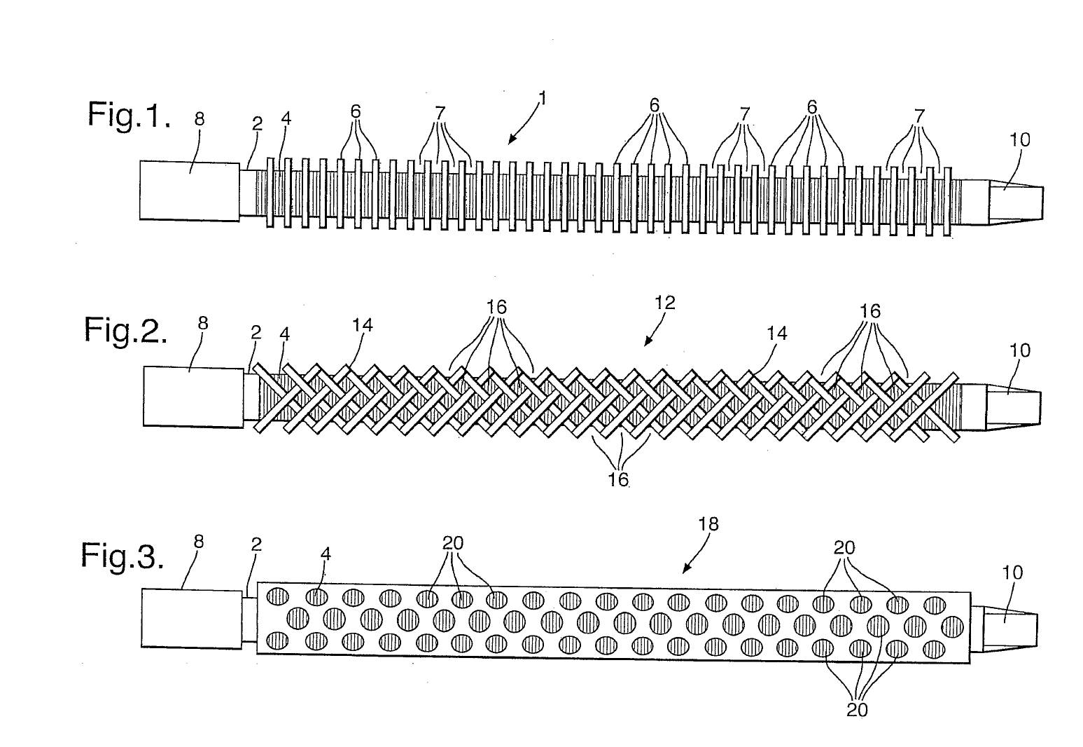

FIG. 2 schematically shows a longitudinal view of a second embodiment of a wellbore screen according to the invention;

FIG. 3 schematically shows a longitudinal view of a third embodiment of a wellbore screen according to the invention;

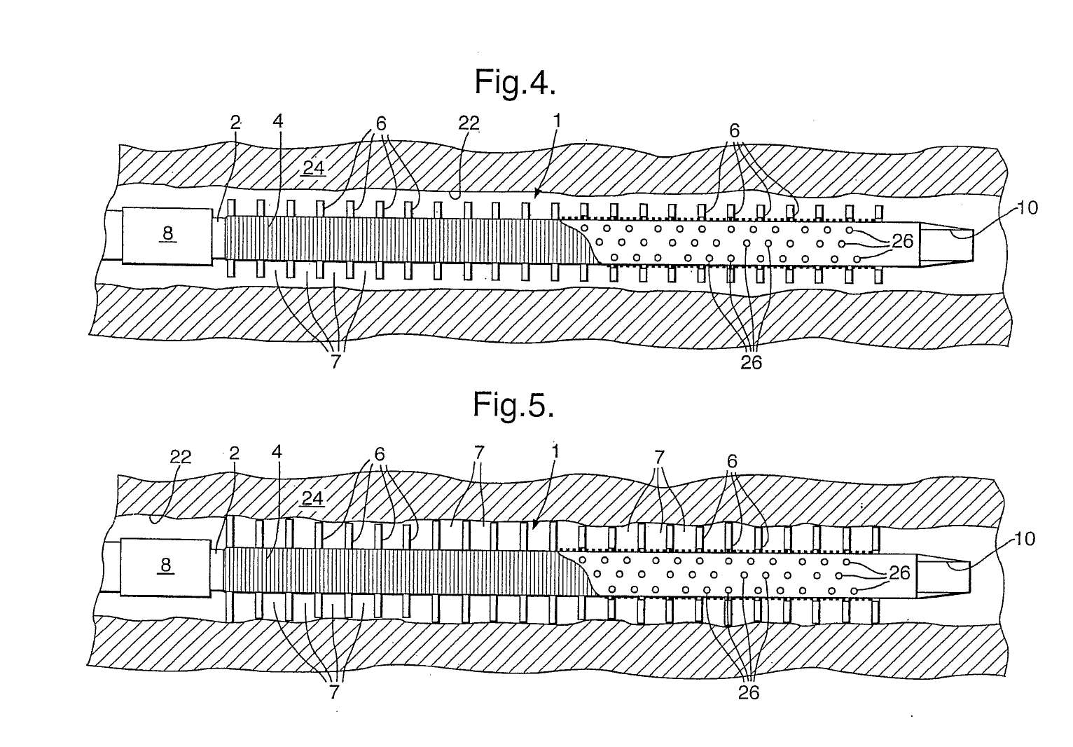

FIG. 4 schematically shows a longitudinal view, partly in section, of the first embodiment of the wellbore screen when installed in a wellbore, before swelling of each swelleable element;

FIG. 5 schematically shows a longitudinal view, partly in section, of the first embodiment of the wellbore screen when installed in the wellbore, after swelling of each swelleable element; and

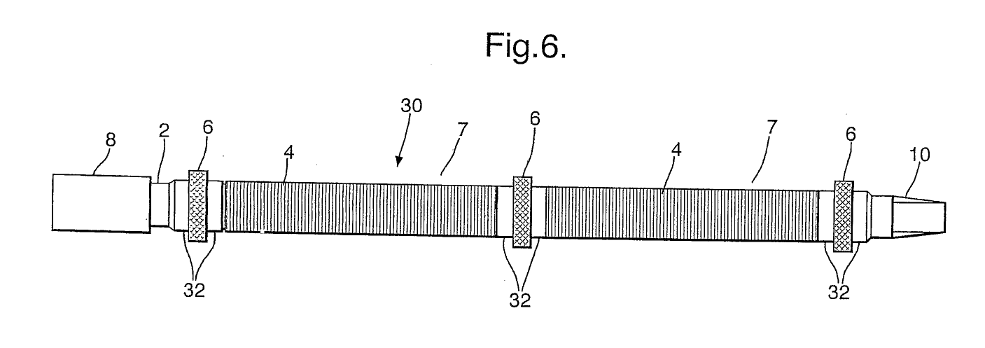

FIG. 6 schematically shows a longitudinal view of a fourth embodiment of a wellbore screen according to the invention.

In the Figures like reference signs relate to like components.

Referring to FIG. 1 there is shown a wellbore screen 1 for use in a wellbore (referred to hereinafter) for the production of oil. The screen 1 comprises a tubular member 2 provided with a filter layer 4 extending around the tubular member 2 and a plurality of swelleable elements in the form of rings 6 extending around the filter layer 4. The rings 6 are arranged at regular spacings along the tubular member 2 thereby defining a plurality of annular compartments 7, each compartment 7 being located between two adjacent rings 6. The filter layer 4 has a sieve opening size adapted to prevent flow of particles from the wellbore wall into the tubular member 2 thereof. The rings 6 are made of an elastomer which swells upon contact with oil produced from the earth formation, the elastomer being for example EPDM rubber. The tubular member 2 is at it ends provided with respective connector portions 8, 10 for connecting the wellbore screen to a production conduit (not shown) for the flow of produced hydrocarbon fluid to a production facility (not shown) at surface.

In FIG. 2 is shown a wellbore screen 12 similar to the wellbore screen 1 of FIG. 1, except that the screen 12 comprises a swelleable element in the form of a sleeve 14 instead of the rings 6 of the FIG. 1 embodiment. The sleeve 14 is provided with a mesh of compartments in the form of substantially rectangular through-openings 16. Similarly to the rings 6 of the FIG. 1 embodiment, the sleeve is made of an oil swelleable rubber such as EPDM.

In FIG. 3 is shown a wellbore screen 18 similar to the wellbore screen 12 of FIG. 2, except that the swelleable element is a sleeve 16 provided with a mesh of substantially circular through-openings 20 instead of the rectangular through-openings 16 of the sleeve 14.

In FIG. 4 is shown the wellbore screen 1 when arranged in a wellbore 22 formed in the earth formation 24, whereby the rings 6 are in their unexpanded state, i.e. before swelling upon contact with hydrocarbon fluid from the earth formation 24. The filter layer 4 is shown partly broken away to indicate perforations 26 arranged in the wall of tubular member 2.

In FIG. 5 is shown the wellbore screen 1 when arranged in the wellbore 22, after the rings 6 have expanded due to contact with hydrocarbon fluid from the earth formation 24. Similarly to FIG. 4, the filter layer 4 is shown partly broken away.

In FIG. 6 is shown a wellbore screen 30 largely similar to the screen of FIG. 1. The screen 30 has only three rings 6 of swelleable elastomer, such as EPDM rubber. Furthermore, the rings 6 are arranged directly around the tubular member 2 and locked in place by respective steel rings 32 which are fixedly connected the tubular element 2, for example by welding. Also, instead of one filter layer as in the previous embodiments, the screen 30 has two separate filter layers 4 whereby each filter 4 layer is arranged between two adjacent rings 6. This embodiment has the advantage that the screen 30 can be easily assembled by sliding the steel rings 32, the elastomer rings 6 and the filter layers 4 over the tubular element 2. If necessary, the steel rings 32 can then be welded to the tubular element 2.

For ease of reference in the above figures, not all rings, compartments, through-openings and perforations have been indicated with a reference sign.

During normal use the wellbore screen 1 of FIGS. 1, 4 and 5 is lowered into the wellbore 22 and positioned in the hydrocarbon producing zone of the earth formation 24. When the wellbore 22 is taken in production, hydrocarbon fluid, such as natural gas or crude oil, flows from the wellbore 22 via the filter layer 4 into the tubular member 2. Thus the hydrocarbon fluid flows along the rings 6 which thereby swell from their unexpanded mode (FIG. 4) to their expanded mode (FIG. 5). Upon swelling the rings 6 become pressed against the wall of the wellbore 22 so that flow of hydrocarbon fluid along the outside of the rings 6 from one of said compartments 7 into another of said compartments 7 is substantially prevented. It is thereby achieved that sand or clay particles which may have locally entered the stream of hydrocarbon fluid, are confined to one or a few compartments 7 only so that spreading of such particles along the entire length of the filter layer 4, which otherwise could lead to clogging of the entire filter layer, is thereby prevented.

Normal use of the wellbore screen 32 of FIG. 6 is similar to normal use of the wellbore screen 1.

Normal use of the wellbore screen 12, 18 of respective FIGS. 2, 3 is similar to normal use of the wellbore screen 1, except that sand or clay particles which have locally entered the stream of hydrocarbon fluid, are confined to one or a few of the respective rectangular through-openings 16 (wellbore screen 12) or circular through-openings (wellbore screen 18).

Instead of all rings of the FIG. 1 embodiment being made of an elastomer which swells upon contact with oil produced from the earth formation, one or more of the rings can be made of a material which swells upon contact with water from the earth formation. For example the rings can include a first set of rings susceptible of swelling in hydrocarbon fluid and a second set of rings susceptible of swelling in formation water, whereby the rings of the first and second sets are arranged in alternating order.

1. A wellbore screen for controlling inflow of solid particles into a wellbore, the wellbore screen comprising a conduit for transport of fluid, the conduit being provided with a filter for reducing inflow of solid particles into the conduit and swelling means arranged between the filter and the wellbore wall, the swelling means defining a plurality of compartments between the filter and the wellbore wall and being susceptible of swelling against the wellbore wall upon contact with a selected fluid so as to substantially prevent flow of fluid along the outside of the swelling means from one of said compartments into another of said compartments.

2. The wellbore screen of claim 1, wherein the swelling means includes a plurality of swelleable rings, each ring extending around the filter and being susceptible of swelling against the wellbore wall upon contact with the selected fluid, the rings being mutually spaced along the conduit.

3. The wellbore screen of claim 2, wherein the rings are arranged at regular mutual spacings along the conduit.

4. The wellbore screen of claim 1, wherein the swelling means includes a sleeve extending around the conduit, the sleeve being provided with a plurality of through-openings spaced along the sleeve.

5. The wellbore screen of claim 4, wherein each through-opening has a substantially rectangular shape or a substantially circular shape.

6. The wellbore screen of claim 1, wherein the swelling means includes a material susceptible to swelling upon contact with hydrocarbon fluid from the earth formation or water from the earth formation.

7. The wellbore screen of claim 6, wherein said material is susceptible to swelling upon contact with water and includes a rubber selected from Nitrile Butadiene rubber, Hydrogenated Nitrile Butadiene rubber, Carboxylated Nitrile Butadiene rubber, Fluor Polymer, TetraFluorEthylene/PolyPropylene, Ethylene-Propylene-Diene Terpolymer rubber, Chloroprene rubber, ChloroSulfonated Polyethylene, Chlorinated Polyethylene, and PolyUrethane rubber.

8. The wellbore screen of claim 6, wherein said material is susceptible to swelling upon contact with hydrocarbon fluid and includes a rubber selected from Natural rubber, Acrylate Butadiene rubber, Butyl rubber, Brominated Butyl rubber, Chlorinated Butyl rubber, Chlorinated Polyethylene, Chloroprene rubber, Styrene Butadiene rubber, Sulphonated Polyethylene, Ethylene Acrylate rubber, Epichlorohydrin Ethylene Oxide Copolymer, Epichlorohydrin Ethylene Oxide Terpolymer, Ethylene-Propylene-Copolymer (Peroxide crosslinked), Ethylene-Propylene-Diene Terpolymer rubber, and Silicone rubber.

9. The wellbore screen of claim 8, wherein said material is selected from Ethylene Propylene Copolymer (Peroxide crosslinked), Ethylene-Propylene-Diene Terpolymer rubber, Butyl rubber, Brominated Butyl rubber, Chlorinated Butyl rubber, and Chlorinated Polyethylene.

10. The wellbore screen of claim 1, wherein the conduit comprises a tubular member and wherein the filter comprises a tubular filter layer extending around the tubular member.

11. The wellbore screen of claim 1, wherein the wellbore is a wellbore for the production of hydrocarbon fluid or water from the earth formation.

12. (canceled)
